(19) United States
(12) Patent Application Publication
(10) Pub. No.: US 2006/0049668 A1
(43) Pub. Date: Mar. 9, 2006

(54) Body comprising a support structure made of assembled partial modules

(76) Inventors: Konrad Eipper, Rottenberg (DE); Wolfgang Fussnegger, Tuebingen (DE); Dieter Lange, Magstadt (DE); Christian Mayer, Renningen (DE); Bernhard Spies, Sindelfingen (DE); Martin Weller, Fichtenberg (DE); Carlos Valdivieso, Tiefenbronn (ES)

Correspondence Address: CROWELL & MORING LLP;INTELLECTUAL PROPERTY GROUP, P.O. BOX 14300, WASHINGTON, DC, 20044-4300, US

(21) Appl. No.: 10/525,720

(22) PCT Filed: Aug. 8, 2003
(86) PCT No.: PCT/EP03/08816

§ 371 Date: Aug. 3, 2005

(30) Foreign Application Priority Data
Aug. 27, 2002 (DE) 102 39 989.1

(51) Int. Cl. B62D 25/00

(52) U.S. Cl. 296/193.04

(57) ABSTRACT

The support structure of a body for a motor, vehicle is assembled from large-size partial modules. Two partial modules connected to each other comprise support sections and wall and/or floor sections connected thereto. Support sections of one partial module are connected to associated support sections of the other partial module at abutment points. In order to design a highly stressed connection between partial modules of the support structure in a very stable and simple manner, the support sections of the two partial modules, which support sections are assigned in each case to one another, are assembled to form a continuous support. Abutting surfaces of the assembled support sections run obliquely with respect to the direction of extent of the support. This oblique profile of the abutting surfaces creates a connection over a very large area in relation to the cross section of the support, which ensures an extremely stable connection of the two parts to each other.

### BACKGROUND AND SUMMARY OF THE INVENTION

This invention relates to a body for a motor vehicle.

A body of this type having a support structure assembled from large-size partial modules is already known from U.S. Pat. No. 4,133,549. In this body, two partial modules which are connected to each other in each case comprise support sections and wall and/or floor sections connected thereto, and support sections of the one partial module are assembled with associated support sections of the other partial module at abutment points to form a continuous support. In this case, the abutting surfaces of the assembled support sections run obliquely with respect to the direction of extent of the support.

This oblique profile of the abutting surfaces produces a connection over a very large area in relation to the cross section of the support, which already ensures a stable connection of the two parts to each other. In addition, the oblique profile of the abutting surfaces already permits manufacturing tolerances to be compensated for in a simple manner since it is possible for the support sections to be adjusted within certain limits, both in the direction of extent of the support and in the vertical direction, by displacing the support sections with respect to each another in the direction of the extent of the support.

A body of this type, the support structure of which is composed of essentially four large-size partial modules, is likewise already known from German document DE 198 33 395 A1. For example, each of a front end module and a basic module of this support structure comprises support sections and wall and/or floor sections connected thereto. When the partial modules are assembled, support sections of the one partial module are connected to associated support sections of the other partial module at abutment points.

The invention is based on the object of providing a body of the type mentioned at the beginning with which a highly stressed connection between partial modules can be realized in an even more stable manner.

This object is achieved according to the invention.

Advantageous refinements of the invention.

In the support structure according to the invention, the support sections are arranged at the sides of a basic module and of a front end module, as a result of which, when they are joined together, lateral sills of the support structure are produced. These sills ensure that the support structure is very highly stable in the connecting region of the two partial modules. The oblique profile of the abutting surfaces can also be formed by a plurality of steps which follow on from one another.

Since upwardly protruding column sections are arranged at the front ends of the lateral longitudinal member sections of the basic module, which column sections are to be connected to upwardly protruding column sections of the lateral longitudinal member sections of the front end module, the overall result is an angled bonding of the column sections to the longitudinal member sections. This makes it possible, for example, for a particularly stiff supporting of a front end module on the basic module to be provided.

If the abutting surfaces of the support sections assigned to one another are of planar design, then a particularly simple configuration of the support sections in the region of the abutting surfaces is possible.

If each of the support sections is formed from a box profile which is closed on the end side by the particular planar abutting surface, then, when they are joined together, a particularly firm connecting region is produced, with the support having a doubled, approximately 8-shaped box profile in cross section.

If the planar abutting surface and the respectively assigned box wall run at an acute angle with respect to each other and form a point of the support section, then the connection of the support section can be improved by means of a fastening tab arranged at the front end of the point. In this case, the fastening tab ensures a particularly good connection of the point of the one support section to the other, as a result of which, for example, a “peeling off”—i.e. a detaching of the one support section from the point—is particularly effectively avoided.

An additional connection and stiffening of the two partial modules is provided if, in addition to the support sections, also the wall and/or floor sections of the modules are connected to one another in an overlapping manner.

In addition, an even more stable connection of the basic module and front end module is produced if, in addition, upwardly protruding column sections of the two modules are connected to one another.

Further advantages, features and details of the invention will emerge from the description below of a preferred exemplary embodiment and with reference to the drawings.

### BRIEF DESCRIPTION OF THE DRAWINGS

FIG. 1 shows a perspective exploded illustration of the support structure of the motor vehicle body according to the invention, which support structure is assembled from large-size partial modules;

FIG. 2 shows a further perspective exploded illustration of the support structure which is assembled from partial modules and is lined with outer panel parts;

FIG. 3 shows a perspective view of a partial module of the support structure designed as a front end module;

FIG. 4 shows a perspective view of a partial module of the support structure designed as a basic module;

FIG. 5 shows a perspective plan view of the basic module and the front end module after they have been joined together; and

FIG. 6 shows a partial side view of the basic module and the front module after they have been joined together.

### DETAILED DESCRIPTION OF THE INVENTION

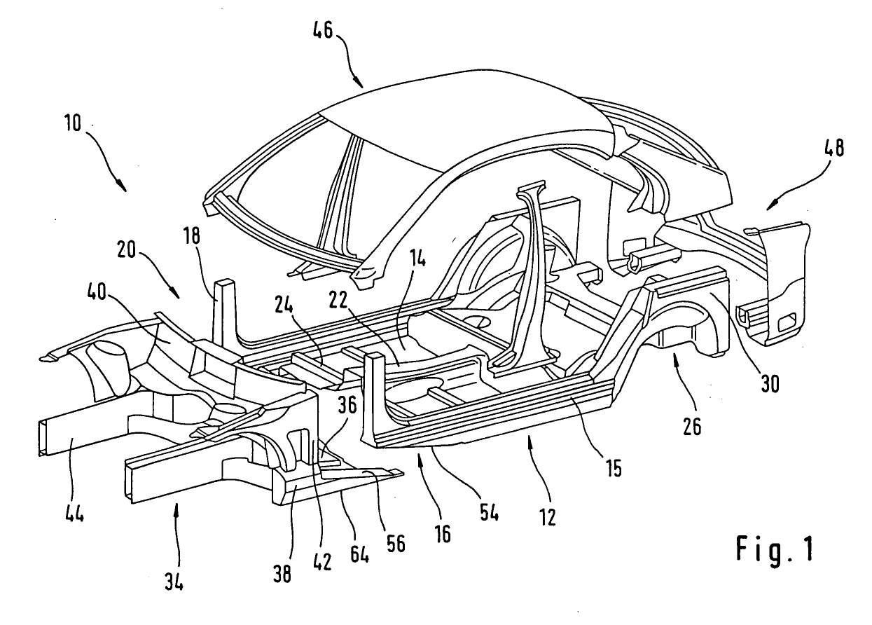

FIG. 1 shows, in a perspective exploded illustration, a support structure 10 of a motor vehicle body that is assembled from a plurality of large-size partial modules which are described in more detail below. In the exemplary embodiment shown here, the partial modules of the support structure 10 are produced in each case from a plurality of sheet-metal parts joined together; at the same time, however, the partial modules may also be pre-manufactured in different constructions, for example as a “space frame”, as plastic parts, metal cast parts, as components in a “sandwich construction” or the like. In particular, combinations of different constructions are also conceivable for the joined-together partial modules, depending on application and loading. The individual modules are joined together in particular via bonding connections, welding connections or the like. At the same time, other customary connections, such as screw connections or the like are conceivable.

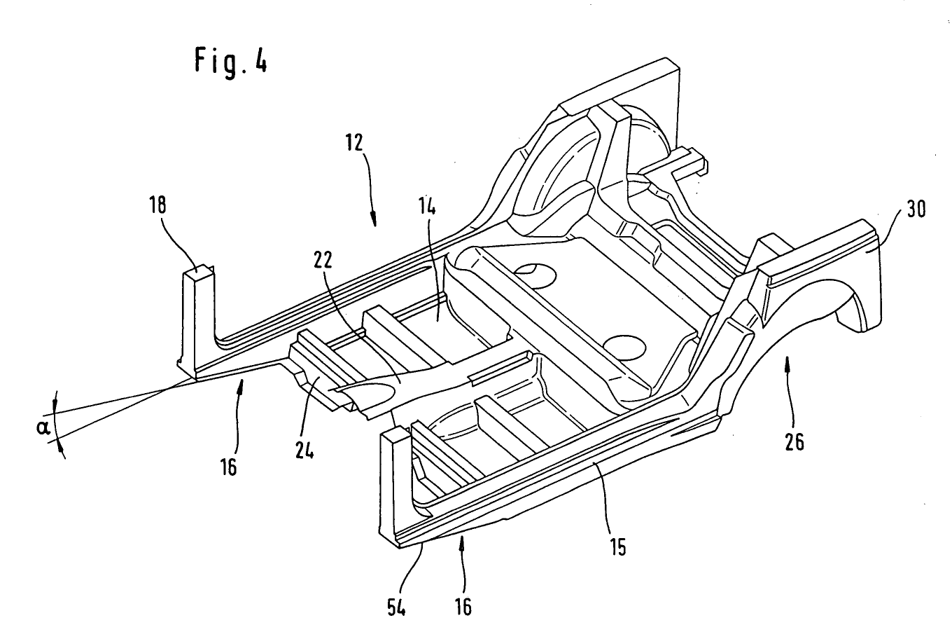

A basic module 12 of the support structure 10, which basic module can be seen in an overall view of FIG. 1 with FIG. 4, essentially comprises a body floor 14 which is bounded laterally by longitudinal members 15. The basic module 12 reaches forward with longitudinal member sections 16 as far as column sections 18 of the front wall columns 20 which protrude upward from the respectively assigned, front ends of the lateral longitudinal member sections 16. The body floor 14 of the basic module 12 ends at a considerable distance behind the front end of the basic module 12 or behind the column sections 18 of the front wall columns 20. In this case, the body floor 14 is provided here with a central tunnel 22 and with crossmembers 24 which extend outward from this central tunnel and are connected fixedly to the longitudinal members 15. At the rear, the basic module 12 ends behind rear wheel houses 26, to the inside of which the lateral longitudinal members 15 extend. Above the rear wheel houses 26, wall regions 30 of the particular, rear side wall are arranged. The basic module 12 is already equipped as far as possible with the other partial modules before it is joined together.

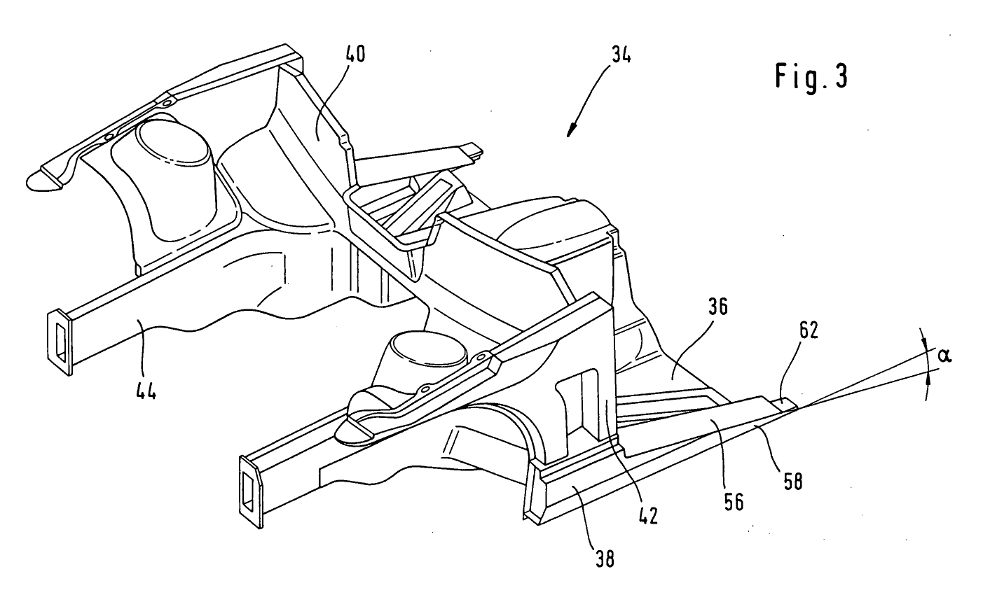

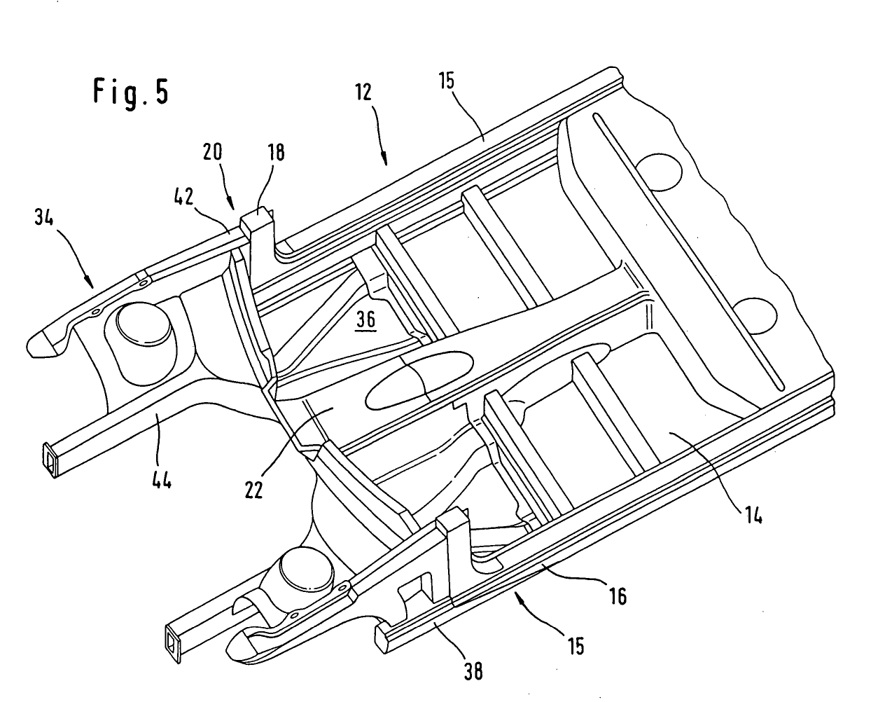

A front end module 34, which can be seen in the overall view of FIG. 3, belongs to the front crumple zone of the motor vehicle, is supported in a crash-stable manner on the basic module 12 in a manner described in more detail below, and is connected to the basic module 12. For this purpose, the front end module 34 comprises a front end region 36 of the body floor 14 which extends between lateral longitudinal member sections 38 of the front end module 34. As can be seen in the overall view of FIG. 5, the front end region 36 of the body floor 14 and the lateral longitudinal member sections 38 end at least approximately level at the rear. At the front, the front end region 36 of the body floor 14 ends at a front end wall 40 of the passenger cell, extending from the front end region 36 of the body floor 14 as far as approximately level with the side wall edge of the support structure 10. The end wall 40 is bounded laterally by column sections 42 of the front wall columns 20 which protrude upward from the lateral longitudinal member sections 38 of the front end module 34. Front longitudinal members 44 can be seen at the front end of the front end module 34. Like the basic module 12, the front end module 34 is also already equipped as far as possible with the other partial modules, assemblies and lining parts before it is joined together.

A roof module 46 can be placed onto the basic module 12 and the front end module 34. At the rear, the basic module 12 is adjoined by a rear module 48 which, when the support structure 10 is assembled, belongs together with the rear end region of the basic module 12 to the rear crumple zone of the motor vehicle.

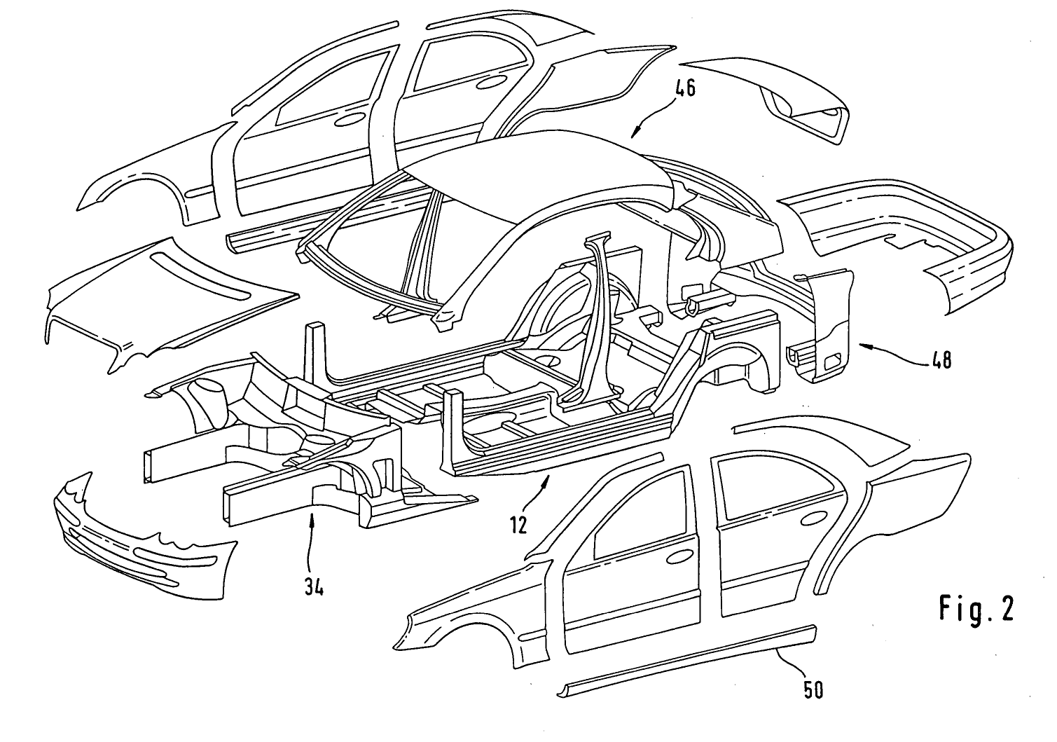

As illustrated in FIG. 2, the support structure 10, which is assembled from the partial modules 12, 34, 46 and 48 is lined with outer panel parts of plastic, sheet metal or the like. Thus, in particular, front wing linings are formed in such a manner that the joining point between the upwardly protruding column sections 18 and 42 of the basic module 12 and of the front end module 34 is covered and cannot be seen from the outside. Lateral sill linings 50 are designed in such a manner that the joining point between the particular longitudinal member sections 16 of the basic module 12 and the longitudinal member sections 38 of the front end module 34 is covered such that it cannot be seen from the outside.

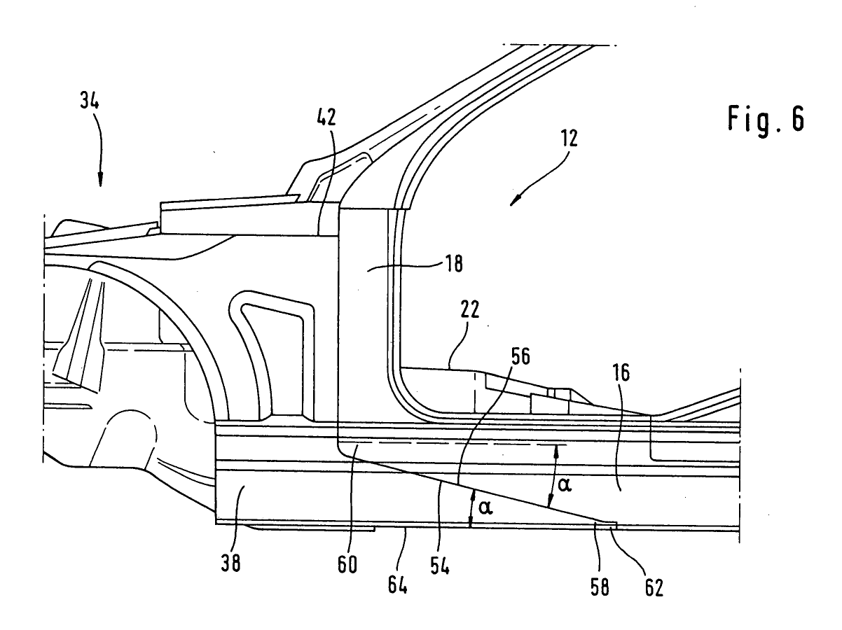

FIGS. 5 and 6 illustrate the basic module 12 and the front end module 34 after they have been joined together, in a perspective plan view and in a partial side view, respectively. It can be seen that the front end region 36 of the body 14, which region belongs to the front end module 34, extends rearward over a considerable length region of the basic module 12 between the lateral longitudinal member sections 16. It can furthermore be seen that the mutually assigned, lateral longitudinal member sections 16, 38 of the front end module 34 and of the basic module 12 are assembled at abutting surfaces 54, 56 of the support sections 16, 38, which abutting surfaces run obliquely with respect to the direction of extent of the support, to form the continuous sill 15. The lateral longitudinal member sections 16, 38 of the front end module 34 and of the basic module 12 are designed here as a box profile of two assembled sheet-metal shells, the longitudinal member sections 16, 38 being closed on the end side, on the mutually facing end sides, in each case by the associated, planar abutting surface 54, 56. The abutting surfaces 54, 56 consist here of continuous, planar sheet-metal sections which are connected peripherally—for example via a welding connection—to the box profile of the longitudinal member sections 16, 38. Of course, it would also be conceivable, instead of the continuous sheet-metal sections completely closing the cross section of the box profile, to make use just of flanges which can be arranged, for example, peripherally on the end side of the box profile. It would also be conceivable for the oblique profile of the abutting surfaces 54, 56 to be able to be formed by a plurality of steps following on from one another. The planar abutting surfaces 54, 56 enclose an acute angle α, with the respectively assigned box wall 60, 64 of the corresponding longitudinal member section 16, 38, so that a point of the corresponding longitudinal member section 16, 38 is formed by the planar abutting surface 54, 56 and the respectively assigned box wall. A fastening tab 62 is provided in each case at the front end of the respective points 58 of the longitudinal member sections 38 of the front end module 34, via which tab the longitudinal member sections 38 of the front end module 34 are additionally connected to the associated longitudinal member sections 16 of the basic module 34. In this case, the fastening tabs 62 are formed by extensions of the lower box wall 64 of the longitudinal member sections 38 and ensure a particularly good connection of the point 58, as a result of which, for example, a peeling off—i.e. a detaching of the support section 38 from the point 58 is particularly effectively avoided.

As FIGS. 5 and 6 show, the abutting surfaces 54, 56 extend over the at least approximately entire overlapping length of the mutually assigned longitudinal member sections 16, 38. In this case, the length of the abutting surfaces 54, 56 corresponds approximately to the length of the adjacent front end region 36 of the body floor 14.

After the longitudinal member sections 16, 38 which are assigned in each case to one another have been joined together, lateral longitudinal members having a box profile which is doubled in cross section and is approximately 8-shaped, are produced. The abutting surfaces 54, 56 are fixed to one another via a bonding connection or similar joining connection and, if appropriate, also via a mechanical connection, such as a screw connection.

The upwardly protruding column sections 18, 42 of the basic module 12 and of the front end module 34 comprise joining surfaces which are matched in each case to one another and via which the column sections 18, 42 are connected to form the front wall column 20. The upwardly protruding column sections 18, 42 in each case comprise a box profile which is closed in cross section, so that, after the associated column sections 18, 42 in each case have been joined together, particularly stiff door columns 20 having a box profile, which is doubled in cross section and is approximately 8-shaped, are created. The angular bonding of the column sections 18 to the longitudinal member sections 16 of the basic module 12 or the angular bonding of the column sections 42 to the longitudinal member sections 38 of the front end module 34 provide a particularly stiff supporting of the front end module 34 on the basic module 12. In the transverse direction of the vehicle, the position of the basic module 12 and of the front end module 34 are not determined by the joining surfaces 54, 56 but rather, for example, by bearing surfaces of the basic module 12 and of the front end module 34 in the region of the central tunnel 22. In other words, the partial modules 12, 34 are aligned in relation to one another in the transverse direction of the vehicle by displacement along the abutting surfaces 54, 56. The front end region 36 of the body floor 14, which end region belongs to the front end module, is connected in an overlapping manner to that region of the body floor 14 which belongs to the basic module 12, as is apparent in particular from FIG. 5. In this case, the central tunnel 22 is molded both into the front end region 36 and into the body floor 14 and is provided with joining surfaces.

It should be considered as being included within the context of the invention that the abutting surfaces 54, 56 may also be of curved design.

1-10. (canceled)

11. A body for a motor vehicle having support structure comprising large-size partial modules, two of said partial modules being connected to each other, each of said two of said partial modules comprising support sections and wall sections, floor sections, or both wall sections and floor sections connected thereto, wherein the support sections of one of said partial modules are connected to associated support sections of the other of said partial modules at abutment points and are assembled to form a continuous support, wherein abutting surfaces of the assembled support sections run obliquely with respect to the direction of extent of the continuous support, wherein the support sections of the large-size partial modules are lateral longitudinal member sections, wherein upwardly protruding column sections are arranged at front ends of the lateral longitudinal member sections of a basic module of said partial modules, and wherein the column sections are to be connected to upwardly protruding column sections of the lateral longitudinal member sections of a front end module of said partial modules.

12. The body as claimed in claim 11, wherein each of the support sections of the two of said partial modules is assigned to the other and has a planar abutting surface.

13. The body as claimed in claim 12, wherein each of the support sections of the two of said partial modules has a box profile which is closed on an end side by the planar abutting surface.

14. The body as claimed in claim 12, wherein each planar abutting surface encloses an acute angle with a respectively assigned box wall of one of the support sections.

15. The body as claimed in claim 14, wherein a point of the support section is formed by the planar abutting surface and the respectively assigned box wall, wherein a fastening tab is provided at a front end of the point, and wherein the support sections which are assigned to one another are additionally connected by the fastening tab.

16. The body as claimed in claim 11, wherein the continuous support includes lateral longitudinal members which bound a body floor, and wherein a front end region of the body floor belongs to the front end module and extends rearwards over a considerable length region of the basic module between the lateral longitudinal member sections.

17. The body as claimed in claim 16, wherein the front end region of the body floor which belongs to the front end module is connected in an overlapping manner to a region of the body floor which belongs to the basic module.

18. The body as claimed in claim 11, wherein the upwardly protruding column sections of the front end module and of the basic module can be connected to form front wall columns.

19. The body as claimed in claim 13, wherein each planar abutting surface encloses an acute angle with a respectively assigned box wall of one of the support sections.

20. The body as claimed in claim 19, wherein a point of the support section is formed by the planar abutting surface and the respectively assigned box wall, wherein a fastening tab is provided at a front end of the point, and wherein the support sections which are assigned to one another are additionally connected by the fastening tab.
